(19) United States
(12) Patent Application Publication
(10) Pub. No.: US 2007/0184879 A1
(43) Pub. Date: Aug. 9, 2007

(54) Relay device for mobile device

(76) Inventor: Takashi Nakai, Fukushima-ken (JP)

Correspondence Address: BRINKS HOFER GILSON & LIONE, P.O. BOX 10395, CHICAGO, IL, 60610, US

(21) Appl. No.: 10/557,676

(22) PCT Filed: May 21, 2004
(86) PCT No.: PCT/JP04/07313

§ 371 Date: Apr. 4, 2007

(30) Foreign Application Priority Data
May 22, 2003 (JP) 2003-144593

(51) Int. Cl. H04B 1/38; H04M 1/00

(52) U.S. Cl. 455/573

(57) ABSTRACT

A relay device including print means that is value-added means is mounted to a mounting recessed portion of a battery charger, and a mobile phone that is a mobile device is mounted to a mounting recessed portion of the relay device. Thus electric power can be supplied to the secondary cell of the mobile phone and the print means of the relay device via the relay device from one battery charger. Characters and images displayed on a display of the mobile phone can be printed by the print means under the control from the mobile phone.

### TECHNICAL FIELD

The present invention relates to a relay device disposed between a mobile device such as a mobile phone and a battery charger, and in particular, it relates to a relay device capable of supplying electric power to a relay device having additional functions and a mobile device with one power source.

### BACKGROUND ART

Recent mobile phones have not only a speech function intended for telephones but also the function of personal digital assistance, facilitating provision of character and image information via the Internet or e-mail.

To print the information obtained by the mobile phones such as contents of e-mail and images, it must normally be transferred to a personal computer as data, and then be printed using a floor-mounted printer connected to the personal computer. This is inconvenient.

In view of such a problem, for example, Japanese Unexamined Patent Application Publication No. 11-320977 discloses a technique of connecting a mobile phone to a printer so that various data can be transferred from the mobile phone to the printer to be printed, thereby removing the inconvenience.

While the patent document describes no specific way of connecting the mobile phone to the printer, there are general methods: (1) a method of connection using a dedicated cable; and (2) a method of connection by radio wave or infrared rays.

In the field of digital cameras, to print data taken by a digital camera, the digital camera is generally connected to a personal computer with a dedicated cable (e.g., a USB cable) to capture the data into the personal computer.

However, rechargeable mobile devices, such as mobile phones and digital cameras, and printers each need a power cable to receive electric power. Thus, at least three kinds of cables are required, posing the problem of complicated wire arrangement.

Moreover, mobile phones generally have a connection terminal for data communication between a plus power terminal and a minus power terminal for receiving electric power, resulting in the inconvenience that the mobile phone cannot be charged while the mobile phone and the printer are connected with the dedicated cable.

Method (2) has the necessity for providing a dedicated radio or optical receiving device and transmitting device on both of a mobile device and a printer. This may result in increasing the manufacturing cost of the mobile device and the printer. Particularly, this may be an obstacle to mobility through the miniaturization of mobile devices.

The invention is made to solve the above-described problems of the related art. Accordingly, it is an object of the invention to provide a relay device that needs no dedicated power cable owing to obtaining electric power using a battery charger attached to a mobile device such as a mobile phone.

It is another object of the invention to provide a relay device disposed between a mobile device and a battery charger, which allows data communication with the mobile device while the mobile device is charged, and which has various additional functions such as print means and storage means.

### DISCLOSURE OF INVENTION

The present invention is a relay device for a mobile device disposed between a rechargeable mobile device and a battery charger for supplying charging power to the mobile device.

The relay device is characterized by including: a receiving connection that receives electric power output from a feeding portion of the battery charger; a feeding connection that relays the received electric power to a receiving connection of the mobile device; a data input/output connection connected to a data connection terminal provided to the mobile device, the connection inputting and receiving data; and value-added means that operates according to the operation of the mobile device.

According to the invention, a relay device can be directly mounted to a battery charger, on which a mobile device can be directly mounted. This eliminates the necessity for a connecting power cable and a data-communication cable. Also, the stack structure allows connection, reducing the area for installation.

Since the supply of electric power into the relay device and the supply of electric power to the mobile device can be made at the same time, for example, the secondary cell of the mobile device can be charged even during the operation of the relay device. In other words, the relay device and the mobile device can be supplied with electric power with one power source.

Since this eliminates the necessity for the mobile device and the relay device to have a radio receiver and a radio transmitter, manufacturing cost can be reduced.

It is preferable that the receiving connection and the receiving portion of the mobile device have the same shape and electrode arrangement, and the feeding connection and the feeding portion of the battery charger have the same shape and electrode arrangement.

With such a structure, the battery charger, the relay device, and the mobile device can be firmly attached to one another.

For example, it is preferable that the value-added means of the relay device be print means for printing data output from the mobile device, print means for printing based on data output from the mobile device, or recording means for recording data output from the mobile device in a recording medium and/or reading means for reading data recorded in the recording medium and outputting the data to the mobile device.

The mobile device may be any of a mobile phone, an electronic notebook, a digital camera, a video camera, and a media player.

### BRIEF DESCRIPTION OF THE DRAWINGS

FIG. 1 is a perspective view of an embodiment of the invention.

FIG. 2 is a cross sectional view of the embodiment of FIG. 1.

FIG. 3 is a partial plan view of the mobile phone and the battery charger.

FIG. 4 is a conceptual diagram of the connection of the power line and the data line among the battery charger, the relay device, and the mobile device.

### BEST MODE FOR CARRYING OUT THE INVENTION

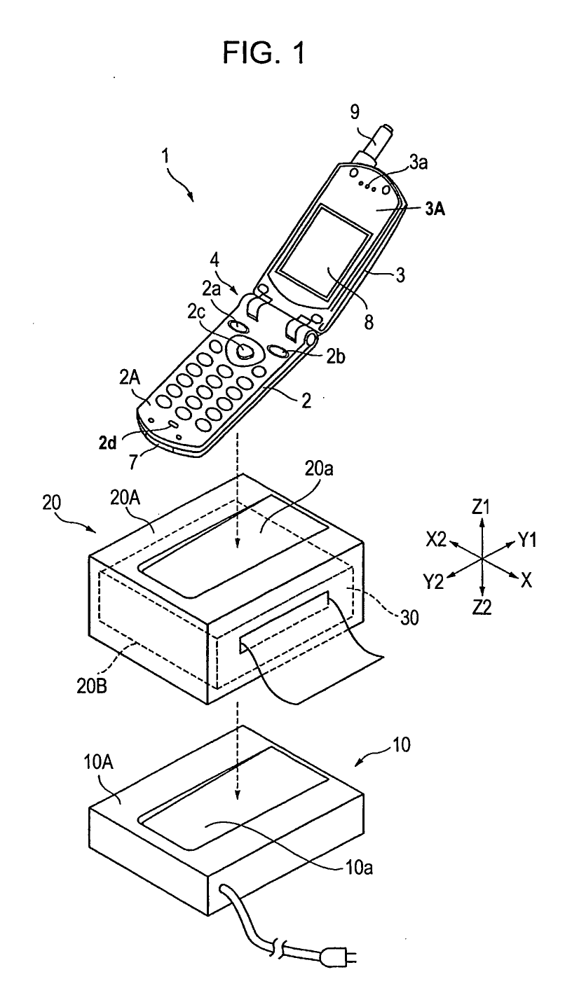

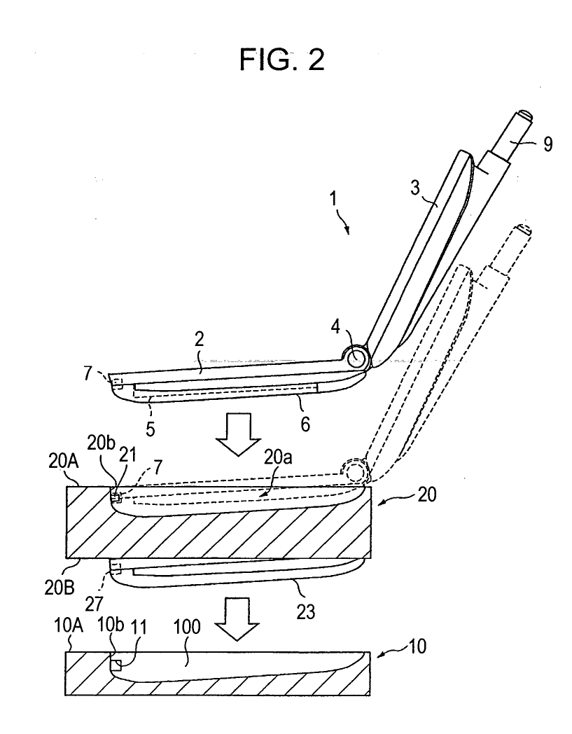

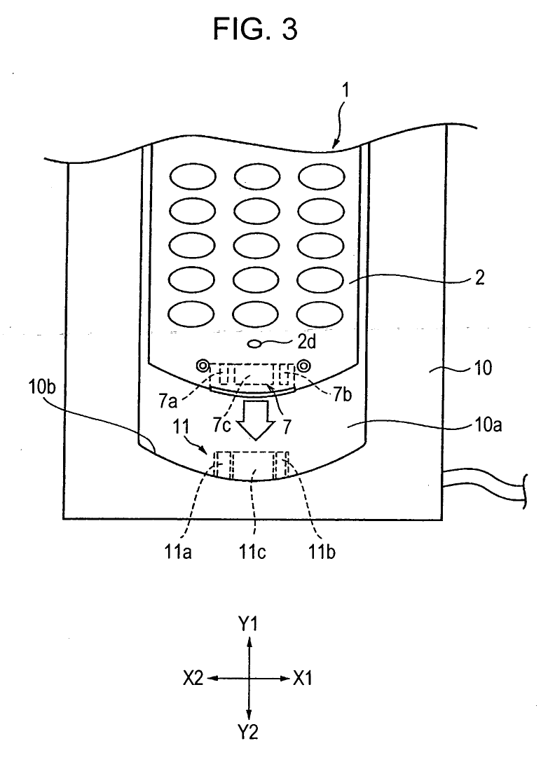

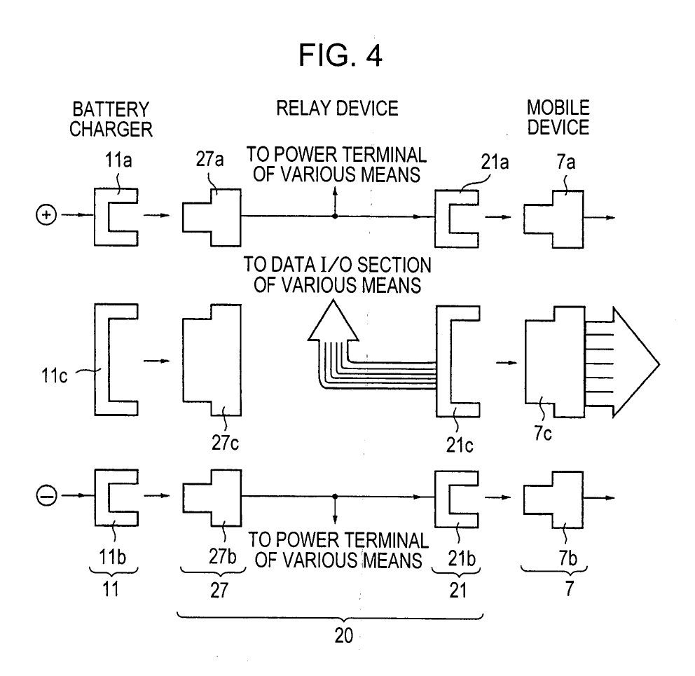

FIG. 1 is a perspective view of an embodiment of the invention; FIG. 2 is a cross sectional view of the embodiment of FIG. 1; FIG. 3 is a partial plan view of the mobile phone and the battery charger; and FIG. 4 is a conceptual diagram of the connection of the power line and the data line among the battery charger, the relay device, and the mobile device.

Referring to FIGS. 1 and 2, reference numeral 1 denotes a mobile phone 1 that is a typical mobile device. The mobile phone 1 is of a flip-up type in which a device main body 2 and a cover 3 are rotatably joined via a hinge 4.

An operating section 2A is disposed on the upper surface of the device main body 2, on which a plurality of buttons such as a selection button 2a, a scroll button 2b, and an enter button are disposed. At the lower end of the operating section 2A in the drawing, a microphone 2d for picking up voice is disposed.

The mobile phone 1 is of a rechargeable type. A battery space is disposed at the lower part of the device main body 2, which houses a secondary cell (battery) 5 that can be repeatedly used by recharging, such as a lithium ion battery. The battery space that houses the secondary cell 5 is covered with a bottom cover 6 that covers the lower surface of the device main body 2.

As shown in FIG. 3, a recessed connector 7 that is recessed to the interior of the device main body 2 is provided in the vicinity of the microphone 2d at the end face of the device main body 2 in the direction of Y2. The recessed connector 7 includes pin-like receiving terminals (receiving portions) 7a and 7b disposed at both ends in the directions X1 and X2, and a data terminal (data connection) 7c in which multiple thin-plate terminals are disposed between the receiving terminals 7a and 7b. The receiving terminal 7a is positive, and the receiving terminal 7b is negative. The receiving terminals 7a and 7b connect to the plus terminal and the minus terminal of the secondary cell 5, respectively. The data terminal 7c is a terminal for transmitting and receiving data, and connects to a controller or memory means (not shown) via the interface circuit in the mobile phone 1.

As shown in FIGS. 1 and 2, the cover 3 includes a display section 3A, on which a display 8 is mounted. A speaker 3a is provided at the upper end of the display section 3A in the drawing. On the back (outer surface) of the cover 3 in the drawing, an extendable antenna 9 is provided.

Reference numeral 10 denotes a battery charger for charging the secondary cell 5. The battery charger 10 comes with the mobile phone 1 as an accessory, e.g., at the purchase of the mobile phone 1. The mobile phone 1 includes therein AC-DC power conversion means for converting commercial AC power of, e.g., AC 100 v in voltage, to a specified direct voltage and direct current. The AC-DC power conversion means includes, e.g., a filter circuit, a rectifier circuit, a DC-DC converter, a rectifier and filter circuit, and a constant-voltage and constant-current control circuit.

The AC-DC power conversion means is not limited to that provided in the battery charger 10, but may be an external AC-DC power conversion means (an AC adapter or the like). In this case, the battery charger 10 substantially functions as connection means for connecting the external AC-DC power conversion means with the mobile phone 1. The connection means (the battery charger 10) and the external AC-DC power conversion means construct the battery charger 10.

On the upper surface 10A of the battery charger 10, a mounting recessed portion 10a is provided for housing the bottom of the device main body 2 of the mobile phone 1. As shown in FIG. 3, a protruding connector 11 that protrudes in the direction Y1 is provided on an inner surface 10b of the mounting recessed portion 10a in the direction Y2 in the drawing. On both ends of the protruding connector 11 in the direction X, feeding terminals (feeding portions) 11a and 11b to be connected to the receiving terminals 7a and 7b of the recessed connector 7 of the mobile phone 1, and a data input/output connection (dummy terminal) 11c to be connected to the data terminal 7c, are provided. To the feeding terminals 11a and 11b, the output of the AC-DC power conversion means is input.

When the device main body 2 of the mobile phone 1 is placed on the mounting recessed portion 10a of the battery charger 10, and slid in the direction Y2, the recessed connector 7 and the protruding connector 11 come into engagement with each other, as indicated by the dotted line of FIG. 2. At that time, the receiving terminals 7a and 7b and the feeding terminals 11a and 11b are connected, and the data terminal 7c and the data input/output connection 11c are connected, respectively.

Reference numeral 20 shown in FIGS. 1 and 2 denotes the relay device of the invention. On the upper surface 20A of the relay device 20, a mounting recessed portion 20a that is the same shape as that of the mounting recessed portion 10a of the battery charger 10 is formed. On the inner surface 20b of the mounting recessed portion 20a in the direction Y2, a protruding connector 21 having the same specifications as those of the protruding connector 11 is provided. The protruding connector 21 has therein feeding terminals (feeding portions) 21a and 21b, and a data input/output connection 21c that is the same as the feeding terminals (feeding connections) 11a and 11b and the data input/output connection 21c of the recessed connector 7.

As shown in FIG. 2, the relay device 20 has a mounting protruding portion 23 on the bottom 20B, which is the same shape as the outer shape of the bottom of the device main body 2 of the mobile phone 1. At the end of the mounting protruding portion 23 in the direction Y2 in the drawing, a recessed connector 27 having the same specifications as those of the recessed connector 7 of the device main body 2 is provided. The recessed connector 27 has therein receiving terminals (receiving connections) 27a and 27b and a data terminal 27c that are the same as the receiving terminals 7a and 7b and the data terminal 7c. As shown in FIG. 4, the feeding terminals (feeding connections) 21a and 21b and the receiving terminals (receiving connections) 27a and 27b are connected, respectively, in the relay device 20. Although the data input/output connection 21c and the data terminal 27c may either be connected or not connected, the output of the data terminal 27c is connected to the data input/output section (not shown)of various value-added means provided in the relay device 20, to be described later.

The relay device 20 shown in FIG. 1 has print means (value-added means) 30. The printer is a known printer, such as a page printer, a page printer, a serial printer, a line printer, an inkjet printer, a dot impact printer, a Bubble Jet™ printer, a Mach-jet printer, a laser printer, an LED printer, a thermal printer, or a sublimatic printer.

The print means 30 may be either of the type that prints roll paper disposed in the relay device 20 or a manual paper feed type that inserts paper one by one from a slot facing the exterior.

The mounting protruding portion 23 of the relay device 20 is fitted in the mounting recessed portion 10a of the battery charger 10.

Furthermore, the mobile phone 1 is fitted in the mounting recessed portion 20a of the relay device 20. Accordingly, as shown in FIG. 4, the receiving terminals 7a and 7b of the mobile phone 1 and the feeding terminals 11a and 11b of the battery charger 10 are connected via the feeding terminals (feeding connections) 21a and 21b and the receiving terminals (receiving connections) 27a and 27b of the relay device 20. This allows recharging of the secondary cell of the mobile phone 1. At that time, also the print means 30 in the relay device 20 is supplied with electric power (direct current and DC voltage). The mobile phone 1 and the print means 30 in the relay device 20 are connected via the data terminal 7c and the data input/output connection 21c. This allows data transmission from the mobile phone 1 to the print means 30 of the relay device 20.

For example, when the mobile phone 1 has an output command for transmitting print data, the contents displayed on the display 8 of the mobile phone 1 can be printed using the print means 30 of the relay device 20.

The mobile device is not limited to a mobile phone, but may be electronic notebooks, digital cameras, video cameras, media players, or other electronic devices. The above-described structure allows the devices to print out the images or characters on the display (the titles of music and the names of players for media players).

The value-added means 30 of the relay device 20 is not limited to print means, but may be storage means such as a hard disk. In this case, music software downloaded from music delivery sites on the Internet using the mobile phone 1 can be stored as music data in the storage means. Image data downloaded from picture or moving-image delivery sites can also be stored in the storage means.

When the value-added means 30 is a hard disk, a large volume of data can be stored. Accordingly, providing the relay device 20 with a secondary cell achieves a portable media player such as an MP3 player.

The value-added means 30 may be means for writing to/reading from storage media, such as memory cards, FDs, and MDs (read/write means). In this case, various data such as character data or picture or moving-image data of mail obtained by the mobile phone 1 can be recorded in recording media, and the various data recorded in the recording media can be read into the mobile phone 1.

Accordingly, the various data stored in the mobile phone 1 can be transferred to recording media before the memory of the mobile phone 1 runs out of capacity.

Furthermore, data recorded in recording media can also be called up to the mobile phone 1, and can be transmitted to the exterior via the mail function of the mobile phone 1.

Although the embodiment has been described for the case of a three-layer structure in which a relay device is mounted on a battery charger, on which a mobile device is mounted, the invention is not limited to that. It may be a four-layer structure in which a relay device including print means is mounted on a battery charger, on which a relay device including storage means is mounted, and on which a mobile device is mounted, or more layers.

Particularly, battery chargers always come with rechargeable mobile phones as accessories at the purchase. The accompanying mobile chargers can therefore be used by the structure in which a relay device including the various value-added means can be connected to the battery charger. This prevents the waste of the accompanying battery chargers as compared with a system in which a battery charger is disposed in a printer.

### INDUSTRIAL APPLICABILITY

According to the invention, a rechargeable mobile device and its battery charger can be connected via a relay device including value-added means such as print means, thus allowing power supply to the value-added means and the secondary cell of the mobile device with one power source.

The invention also allows data communication between a mobile device and various value-added means.

1. A relay device for a mobile device disposed between a rechargeable mobile device and a battery charger for supplying charging power to the mobile device, the relay device comprising:
a receiving connection that receives electric power output from a feeding portion of the battery charger; a feeding connection that relays the received electric power to a receiving portion of the mobile device; a data input/output connection connected to a data connection terminal provided to the mobile device, the connection transmitting and receiving data; and value-added means that operates according to operation of the mobile device.

2. The relay device for a mobile device according to claim 1, wherein the receiving connection and the receiving portion of the mobile device have the same shape and electrode arrangement, and the feeding connection and the feeding portion of the battery charger have the same shape and electrode arrangement.

3. The relay device for a mobile device according to claim 1, wherein the value-added means is print means for printing based on data output from the mobile device.

4. The relay device for a mobile device according to claim 1, wherein the value-added means is storage means for storing data output from the mobile device.

5. The relay device for a mobile device according to claim 1, wherein the value-added means is at least one of: recording means for recording data output from the mobile device in a recording medium or reading means for reading data recorded in the recording medium and outputting the data recorded in the recording medium to the mobile device.

6. The relay device for a mobile device according to claim 1, wherein the mobile device is at least one of a mobile phone, an electronic notebook, a digital camera, a video camera, or a media player.

7. The relay device for a mobile device according to claim 2, wherein the value-added means is print means for printing based on data output from the mobile device.

8. The relay device for a mobile device according to claim 2, wherein the value-added means is storage means for storing data output from the mobile device.

9. The relay device for a mobile device according to claim 2, wherein the value-added means is at least one of: recording means for recording data output from the mobile device in a recording medium or reading means for reading data recorded in the recording medium and outputting the data recorded in the recording medium to the mobile device.

10. The relay device for a mobile device according to claim 2, wherein the mobile device is at least one of a mobile phone, an electronic notebook, a digital camera, a video camera, or a media player.
